(19) United States
(12) Patent Application Publication
(10) Pub. No.: US 2008/0091422 A1
(43) Pub. Date: Apr. 17, 2008

(54) SPEECH RECOGNITION METHOD AND APPARATUS THEREFOR

(76) Inventors: Koichi Yamamoto, Kawasaki-shi (JP); Yasuyuki Masai, Yokohama-shi (JP); Makoto Yajima, Tachikawa-shi (JP); Kohei Momosaki, Kawasaki-shi (JP); Kazuhiko Abe, Yokohama-shi (JP); Munehiko Sasajima, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/951,374

(22) Filed: Dec. 6, 2007

Related U.S. Application Data
(62) Division of application No. 10/888,988, filed on Jul. 13, 2004.

(30) Foreign Application Priority Data
Jul. 30, 2003 (JP) 2003-203660

(51) Int. Cl. G10L 15/00

(52) U.S. Cl. 704/233; 704/E11.003

(57) ABSTRACT

A speech recognition method includes inputting an audio signal including a speech signal and a non-speech signal, discriminating a signal mode of the audio signal, processing the audio signal according to a discrimination result of the discriminating to separate substantially the speech signal from the audio signal, and subjecting the separated speech signal to speech recognition.

### CROSS-REFERENCE TO RELATED APPLICATIONS

The present divisional application claims the benefit of priority under 35 U.S.C. §120 to application Ser. No. 10/888,988, filed on Jul. 13, 2004, and under 35 U.S.C. §119 from Japanese Patent Application No. 2003-203660, filed Jul. 30, 2003, the entire contents of both are hereby incorporated herein by reference.

### BACKGROUND OF THE INVENTION

1. Field of the Invention

The present invention relates to a speech recognition method for recognizing a speech from an audio signal including a speech signal and a non-speech signal, and an apparatus therefor.

2. Description of the Related Art

In the case of performing speech recognition on an audio signal including an audio signal input by a television broadcasting media, a communication media or a storage medium, if the input audio signal is a signal of a single channel, it is input to a recognition engine as it is. On the other hand, if the input audio signal is a bilingual broadcast signal including, for example, a main speech and a sub speech, the main speech signal is input to the recognition engine. If it is a stereophonic broadcast signal, a signal of a right channel or a left channel is input to the recognition engine.

When the input audio signal is subjected to the speech recognition as it is, as described above, recognition precision is extremely deteriorated, if a non-speech signal such as music or noise, or a speech signal of a language different from a recognition dictionary is included in the audio signal, On the other hand, a document: “Two-Channel Adaptive Microphone Array with Target Tracking” Yoshifumi NAGATA and Masato ABE, J82-A, No. 6, pp. 860-866, June, 1999, discloses an adaptive microphone array extracting a speech signal of an object sound using a phase difference between channels. When the adaptive microphone array is used, only a desired speech signal can be input to the recognition engine. As a result, the above problem is solved. However, since the conventional speech recognition technology subjects an input audio signal to speech recognition as it is, recognition precision is extremely deteriorated, if a non-speech signal such as music or noise, or a speech signal of a language different from a recognition dictionary is included in the audio signal.

On the other hand, if the adaptive microphone array is used, only an audio signal theoretically including no noise can be input to the speech recognition engine. However, this method removes an unnecessary component by sound collecting using a microphone and signal processing to extract a desired audio signal. Therefore, it is difficult to extract only a speech signal from an audio signal including already a speech signal and a non-speech signal like an audio signal input by, for example, a broadcast media, a communication media or a storage medium.

### BRIEF SUMMARY OF THE INVENTION

The object of the present invention is to provide a speech recognition method which can carry out speech recognition at high accuracy with affection of a non-speech signal or another speech signal to a desired speech signal of an input audio signal being suppressed at minimum, and an apparatus therefor.

An aspect of the present invention is to provide a speech recognition method comprising: inputting an audio signal including a speech signal and a non-speech signal; discriminating a signal mode of the audio signal; processing the audio signal according to a discrimination result of the discriminating to separate substantially the speech signal from the audio signal; and speech-recognizing the speech signal separated.

Another aspect of the present invention is to provide a speech recognition apparatus comprising: an input unit configured to input an audio signal including a speech signal and a non-speech signal; a discrimination unit configured to discriminate a signal mode of the audio signal; a processing unit configured to process the audio signal according to a discrimination result of the discrimination unit to separate substantially the speech signal from the audio signal; and a speech recognition unit configured to subject the separated speech signal to a speech recognition.

### BRIEF DESCRIPTION OF THE SEVERAL VIEWS OF THE DRAWING

FIG. 1 is a block diagram of a configuration of a speech recognizer according to a first embodiment of the present invention.

FIG. 2 is a block diagram for explaining a concrete example of an audio signal input unit in the embodiment.

FIG. 3 is a diagram of which shows a frequency spectrum of multiplex signal in television broadcasting.

FIG. 4 is a flowchart showing a procedure of speech recognition in the embodiment.

FIG. 5 is a block diagram showing a configuration f a speech recognizer according to the second embodiment of the present invention.

FIG. 6 is a flowchart showing a procedure of speech recognition in the embodiment.

### DETAILED DESCRIPTION OF THE INVENTION

The embodiment of the present invention is described with reference to drawings.

### First Embodiment

FIG. 1 shows a speech recognizer according to the first embodiment of the present invention. An audio signal including a speech signal and a non-speech signal is input from, for example, a television broadcasting media, a communication media or a storage medium. The speech signal is a signal of the speech which a human utters, and the non-speech signal is a signal except for the speech signal, for example, a music signal or noise.

The audio signal input unit 11 is a receiver such as a television receiver or a radio broadcast receiver, a video player such as a VTR or a DVD player, or an audio signal processor of a personal computer. When the audio signal input unit 11 is an audio signal processor in the receiver such as the television receiver or the radio broadcast receiver, an audio signal 12 and a control signal 13 described below are output from the audio signal processor 11.

The control signal 13 from the audio signal input unit 11 is input to the signal mode discriminator 14. The signal mode discriminator 14 discriminates a signal mode of the audio signal 12 based on the control signal 13. The signal mode represents, for example, a monaural signal, a stereo signal, a multiple-channel signal, a bilingual signal or a multilingual signal.

The audio signal 12 from the audio signal input unit 11 and the discrimination result 15 of the signal mode discriminator 14 are input to the speech signal emphasis unit 16. The speech signal emphasis unit 16 decays the non-speech signal such as music signal or noise included in the audio signal 12 and emphasizes only the speech signal 17. In other words, the speech signal emphasis unit 16 substantially separates the speech signal from the audio signal. More specifically, the speech signal is separated from a signal except for the speech signal, that is, the non-speech signal. The speech signal 17 emphasized with the speech signal emphasis unit 16 is subjected to speech recognition with the speech recognition unit (recognition engine) 18 to obtain a recognition result 19.

According to the present embodiment as thus described, since only the speech signal 17 in the audio signal 12 can be subjected to speech recognition, it is possible to obtain a recognition result of high precision without affect of the non-speech signal such as the music signal or noise included in the audio signal 12.

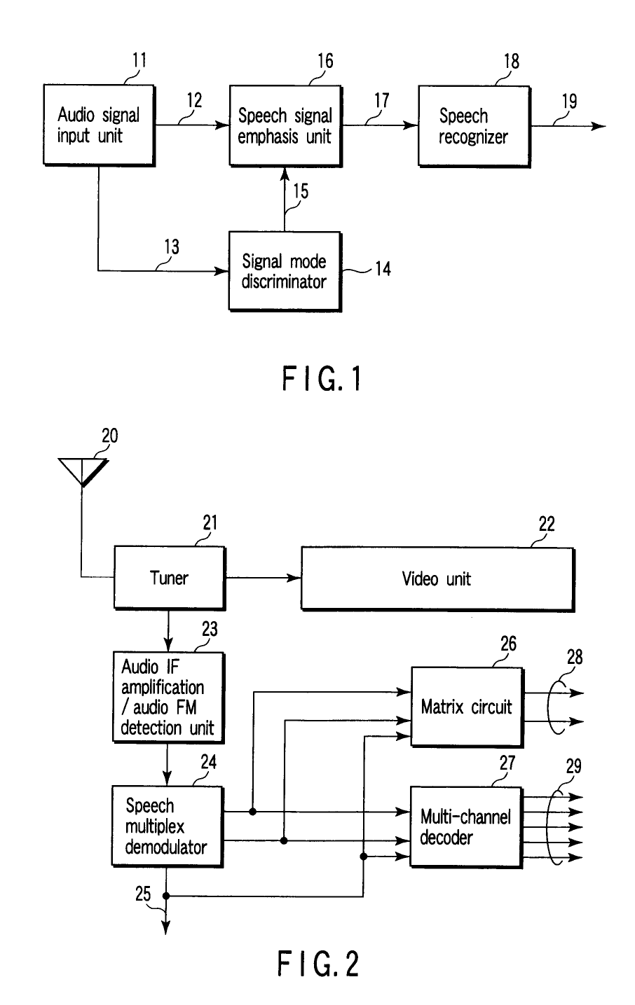

The speech recognition apparatus according to the present embodiment will be concretely described. FIG. 2 shows configuration of the main portion of a television receiver. The television broadcast signal received with a radio antenna 20 is input to a tuner 21 to derive a signal of a desired channel. The tuner 21 separates the derived signal into a video carrier component and an audio carrier component, and outputs them. The video carrier component is input to a video unit 22 to demodulate and reproduce the video signal.

On the other hand, the audio carrier component is converted to an audio IF frequency with an audio IF amplification/audio FM detection circuit 23. Further, it is subjected to amplification and FM detection to derive an audio multiplex signal. The multiplex signal is demodulated with an audio multiplex demodulator 24 to generate a main audio channel signal 31 and a sub audio channel signal 32.

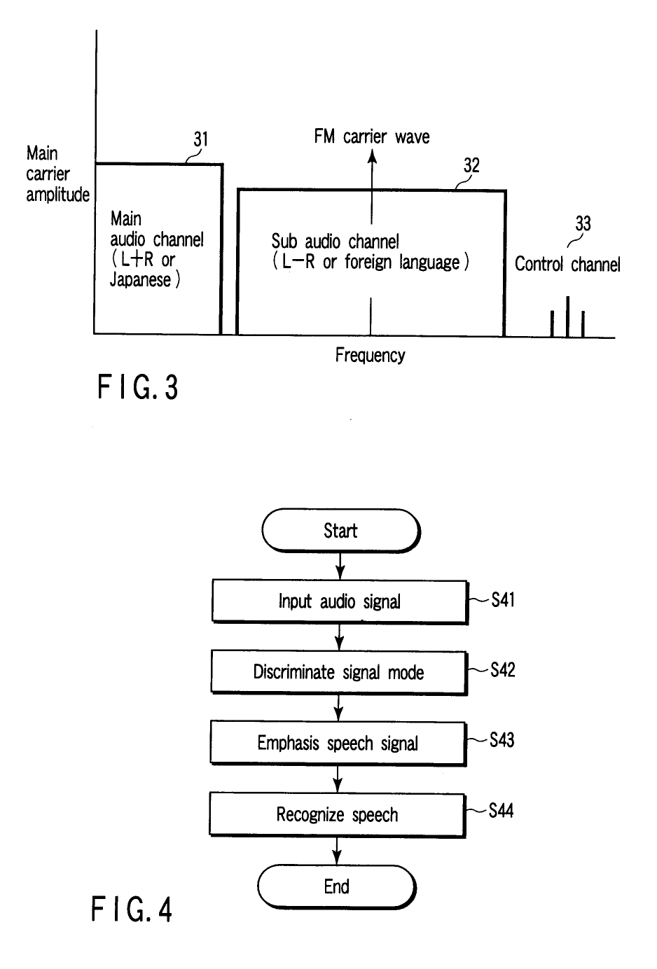

FIG. 3 shows a frequency spectrum of the multiplex signal. The main audio channel signal 31, the sub audio channel signal 32 and a control channel signal 33 are sequentially arranged toward an increasing frequency. If the multiplex signal is a stereo signal, the main audio channel signal 31 is a sum signal L+R of a left (L) channel signal and a right (R) channel signal, and the sub audio channel signal 32 is a difference signal L−R. If the audio multiplex signal is a bilingual signal, the main channel signal 31 is a speech signal of, for example, Japanese speech, and the sub audio channel signal 32 is a speech signal of a foreign language (English, for example).

Further, the audio multiplex signal may be a so-called multiple-channel signal not less than three channels or a multilingual signal other than the stereo signal and bilingual signal. The control channel signal 33 is a signal indicating that the audio multiplex signal is which of the signal modes described before, and is ordinally transmitted as an AM signal.

Referring to FIG. 2, the audio multiplex demodulator 24 outputs a control signal 25 indicating a signal mode detected from the control channel signal 33, as well as only the main audio channel signal and the sub audio channel signal. The main audio channel signal, sub audio channel signal and control signal 25 output from the audio multiplex demodulator 24 are input to the matrix circuit 26 and a multiple-channel decoder 27 to be provided as needed.

When the audio multiplex signal is a bilingual signal, the matrix circuit 26 recognizes according to control signal 25 that it is a bilingual signal, and separates it into a Japanese speech signal of the main speech channel signal and a foreign language speech signal of the sub audio channel signal.

When the audio multiplex signal is a stereo signal, the matrix circuit 26 recognizes that the audio multiplex signal is a stereo signal, according to the control signal 25, and separates the stereo signal into a L-channel signal and a R-channel signal by computing a sum (L+R)+(L−R)=2L of the L+R signal of the main audio channel signal and the L−R signal of the sub audio channel signal and a difference (L+R)−(L−R)=2R. As thus described, a two-channel signal 28 that is a bilingual signal or a stereo signal is output from the matrix circuit 26.

On the other hand, when the signal mode of the audio multiplex signal is a multiple-channel signal such as 5.1-channel signal, a multiple-channel decoder 27 recognizes that the audio multiplex signal from the control signal 25 is a multiple-channel signal, and executes a decoding process. Further, it divides the signal of each channel such as the 5.1 channel signal to output it as a multiple-channel signal 29.

The two-channel signal (bilingual signal or stereo signal) 28 output from the matrix circuit 26 or the multiple-channel signal 29 output from the multiple-channel decoder 27 is supplied to a speaker via an audio amplifier circuit (not shown) to output a sound.

The audio signal input unit 11 shown in FIG. 1 corresponds to, for example, the audio IF amplification/audio FM detector circuit 23, the audio multiplex demodulator 24, the matrix circuit 26 and the multiple-channel decoder 27 in FIG. 2. In this case, the two-channel signal 28 from the matrix circuit 26 or the multiple-channel signal 29 from the multiple-channel decoder 27 is the audio signal 12 from the audio signal input unit 11. The control signal 25 output from the multiplex demodulator 24 corresponds to the control signal 13 output from the audio signal input unit 11.

The signal mode discriminator 14 in FIG. 1 determines whether the audio signal 12 is a monaural signal, a stereo signal, a multiple-channel signal, a bilingual signal, or a multilingual signal according to the control signal 13 from the audio signal input unit 11. When the audio signal 12 is a WAVE file, the header information of the WAVE file is extracted as the control signal 13 from the audio signal input unit 11. When this header information is read with the signal mode discriminator 14, the signal mode, that is, the number of channels can be determined.

When the signal mode discriminator 14 determines that the audio signal 12 is a stereo signal, the audio signal emphasis unit 16 emphasizes the speech signal 17 of the audio signal 12 using information of the L- and R-channel signals, and sends it to the speech recognizer 18. For example, phase information is given as information of the L- and R-channel signals to be used in the speech emphasis unit 16. Conventionally, the audio signal component of the stereo signal has no phase difference between the L- and R-channels. In contrast, the non-speech signal such as music signal or noise signal has a large phase difference between the L- and R-channels, so that only a speech signal can be emphasized (or extracted) using the phase difference.

A speech extraction technique to use a phase difference between the channels is described in the document: “Two-Channel Adaptive Microphone Array with Target Tracking”. According to the document, when two microphones are disposed toward an arrival direction of an object sound, the object sound arrives at the microphones at the same time, and is output as an inphase signal from each microphone. Therefore, obtaining the difference between the outputs of the microphones removes the object sound component and remains spurious sound from a direction different from the object sound. In other words, subtracting the difference between the outputs of the two microphones from the sum of them makes it possible to remove the spurious sound component and extract the object sound component.

Using the principle described in the document, the audio signal emphasis unit 16 derives a difference between L- and R-channel signals, removes a speech signal substantially having no phase difference between the L- and R-channels, and extracts only a non-speech signal having a large phase difference. Then, it extracts only the speech signal 17 by subtracting the non-speech signal from the L- and R-channel signals to emphasize it.

The speech signal emphasis unit 16 can emphasize the speech signal by subjecting the input audio signal 12 to band limiting using a bandpass filter, a lowpass filter or a highpass filter.

In the case that the signal mode discriminator 14 determines that the audio signal 12 is a multiple-channel signal such as 5.1-channel signal, too, the speech signal can be extracted using a phase difference of each channel or a band limitation of spectrum and sent it to the speech recognizer 18.

When the signal mode discriminator 14 discriminates that the audio signal 12 is a bilingual signal, speech signals of different languages such as Japanese and English are included in the main speech channel signal and sub speech channel signal.

If a signal common to the main and sub channel signals exists, the common signal is a non-speech signal such as a music signal or noise, or a signal in an identical language interval, that is, an interval in which the main and sub channel signals have the identical language.

Consequently, if the speech signal emphasis unit 16 subtracts the signal common to the main and sub speech channel signals from them, it is possible to remove a non-speech component unnecessary for speech recognition and a signal in an interval of a language different from a recognition dictionary, and extract only an audio signal 17 from the main or sub speech channel signal. Even if the signal mode discriminator 14 discriminates that the audio signal 12 is a multilingual signal not less than three countries, the same effect can be obtained.

According to the present embodiment as described above, the non-speech signal unnecessary for the speech recognition can be removed from the audio signal 12 according to the discrimination result 15 of the signal mode discriminator 14 in the audio signal emphasis unit 16. Consequently, only the speech signal 17 from which the non-speech signal is removed is sent from the speech signal emphasis unit 16 to the speech recognizer 18, resulting in improving exponentially the recognition accuracy.

A routine for executing the speech recognition relative to the embodiment by software will be explained referring to a flowchart shown in FIG. 4. When an audio signal is input (step S41), at first a signal mode is determined (step S42). Next, a non-speech signal is removed from the multi-channel audio signal, using, for example, phase information of a signal of each channel, or a signal component common to each channel according to a signal mode discrimination result, and only a speech signal is extracted (step S43). In the last, the speech recognition is done by subjecting the extracted speech signal to an recognition engine (step S44).

### Second Embodiment

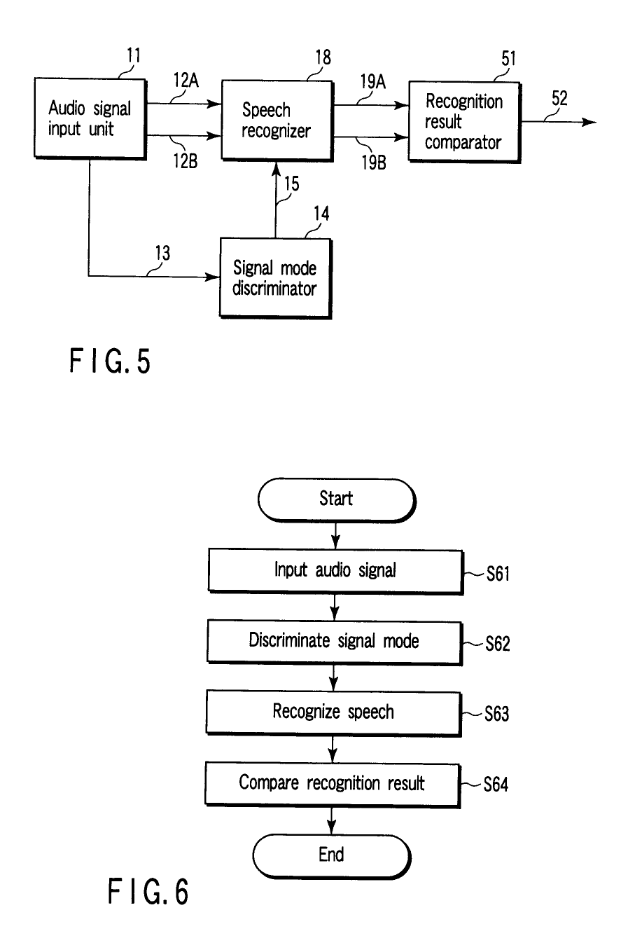

There will be explained the second embodiment of the present invention. FIG. 5 shows configuration of a speech reorganization apparatus related to the second embodiment. In the second embodiment, like reference numerals are used to designate like structural elements corresponding to those like in the first embodiment and any further explanation is omitted for brevity's sake. In the second embodiment, the audio signal input with the audio signal input unit 11 is directly input to the speech recognizer 18. The audio signal input from the audio signal input unit 12 is supplied to the signal mode discriminator 14 to discriminate a signal mode. When the signal mode is determined to be, for example, a bilingual signal, the main speech channel signal 12A and sub speech channel signal 12B that form the input audio signal are recognized with the speech recognizer 18.

For the purpose of recognizing the main speech channel signal 12A and sub speech channel signal 12B, the speech recognition unit 18 uses, as audio and language dictionaries, the identical dictionaries for the main and sub speech channel signals, respectively. The speech recognition unit 18 outputs recognition results 19A and 19B to the main speech channel signal 12A and sub speech channel signal 12B. The recognition results 19A and 19B are input to the recognition result comparator 51. The recognition result comparator 51 performs the following comparison to the recognition results 19A and 19B to derive a final recognition result 52.

Usually, in a bilingual signal provided by the sound multiplex broadcast of the television, different languages such as Japanese and English are used for the main speech channel signal 12A and sub speech channel signal 12B. Consequently, it can be considered that the interval in which the recognition results 19A and 19B to the main speech channel signal 12A and sub speech channel signal 12B agree with each other is an identical language interval or an identical signal interval corresponding to a non-speech interval such as a music signal or noise.

The recognition result comparator 51 compares the recognition results 19A and 19B to the main and sub speech channel signals 12A and 12B output from the speech recognition unit 18 with each other, and determines the identical signal interval such as the identical language interval or non-speech interval. If a part recognition result in the identical signal interval is deleted from the recognition result 19A or 19B, it is possible to delete a recognition result except for a speech signal of a desired language, and derive a right final recognition result 52 to the speech signal of the desired language.

In the case that, for example, the main speech channel signal 12A is a Japanese speech signal, and the sub speech channel signal 12B is an English speech signal, if the speech recognizer 18 uses a Japanese dictionary as a recognition dictionary, it can be considered that the main speech channel signals 12A and sub speech channel signal 12B both are the English speech signal or the non-speech signal such as music signal or noise in an interval in which the recognition results 19A and 19B output from the speech recognizer 18 coincide with each other. Consequently, deleting a part of the recognition result 19A in the interval in which it coincide with the recognition result 19B can provide a more accurate final recognition result 52.

Similarly, when the signal mode discriminator 14 determines that the audio signal input from the audio signal input unit 11 is a multilingual signal, it may be considered that the interval in which the recognition results to the speech signals of respective languages coincide with each other is the identical signal interval such as identical language signal or non-speech signal. Consequently, deleting a part recognition result in the identical signal interval from a recognition result to a channel signal of a desired language makes it possible to obtain correctly a final recognition result 52 to a speech signal of a desired language.

A routine for executing a speech recognition process related to the present embodiment by software is explained by flowchart shown in FIG. 6. When the audio signal is input (step S61), discrimination of a signal mode (step S62) and speech recognition to a speech signal of each channel (step S63) are done.

A plurality of recognition results obtained in step S53 are compared with each other. If the discrimination result of the signal mode is, for example, a bilingual signal or a multilingual signal, a final recognition result to only a speech signal of a desired language is output by subtracting a part recognition result of the identical signal interval from each recognition result (step S64).

In each embodiment, the input audio signal is a sound multiplex signal included in a broadcast signal of a television and so on, and a multi-audio channel signal such as a stereo signal, a bilingual signal, a multilingual signal or a multiple-channel signal is provided by the sound multiplex signal. However, even if the audio signals of the multi-audio channel signal are provided by independent channels, the embodiment can be applied thereto.

A part of a speech recognition process of each embodiment or all thereof can be executed by software. According to the present invention, it is possible to derive a high accurate recognition result to a speech signal without influence of a non-speech signal included in an input audio signal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech recognition method comprising: inputting an audio signal including a speech signal and a non-speech signal;
discriminating a signal mode of the audio signal;
processing the audio signal according to a discrimination result of the discriminating to separate substantially the speech signal from the audio signal; and
speech-recognizing the speech signal separated.

2. The method according to claim 1, wherein the discriminating includes determining that which one of a monaural signal, a stereo signal, a multiple-channel signal, a bilingual signal and a multilingual signal is the audio signal.

3. The method according to claim 1, wherein the processing includes deriving a difference between left-and right-channel signals of a stereo signal as the audio signal, removing a speech signal substantially having no phase difference between the left- and right-channel signals to extract only a non-speech signal having a large phase difference therebetween, and extracting only the speech signal by subtracting the non-speech signal from the left- and right-channel signals.

4. The method according to claim 1, wherein the processing includes emphasizing the speech signal by subjecting the audio signal to filtering.

5. A speech recognition apparatus comprising:
an input unit configured to input an audio signal including a speech signal and a non-speech signal;
a discrimination unit configured to discriminate a signal mode of the audio signal;
a processing unit configured to process the audio signal according to a discrimination result of the discrimination unit to separate substantially the speech signal from the audio signal; and
a speech recognition unit configured to subject the separated speech signal to a speech recognition.

6. The speech recognition apparatus according to claim 5, wherein the discrimination unit is configured to determine that which one of a monaural signal, a stereo signal, a multiple-channel signal, a bilingual signal and a multilingual signal is the audio signal.

7. The speech recognition apparatus according to claim 5, wherein the discrimination unit is configured to discriminate whether the signal mode indicates a stereo signal including a left channel signal and a right channel signal, and the processing unit is configured to process the audio signal according to a phase difference between the left channel signal and the right channel signal to separate substantially the speech signal from the audio signal when the discrimination unit determines that the signal mode indicates the stereo signal.

8. The speech recognition apparatus according to claim 7, wherein the processing unit is configured to compute a difference between the left channel signal and the right channel signal to detect the non-speech signal and subtract the non-speech signal from the left channel signal or the right channel signal to emphasize the speech signal.

9. The speech recognition apparatus according to claim 5, wherein the discrimination unit is configured to determine whether the signal mode indicates a multiple-channel signal, and the processing unit is configured to process the audio signal according to a phase difference between the multi-channel signals to separate substantially the speech signal from the audio signal when the discrimination unit determines that the signal mode indicates the multiple-channel signal.

10. The speech recognition apparatus according to claim 5, wherein the discrimination unit is configured to discriminate whether the signal mode indicates a sound multiplex signal including a main speech channel signal and a sub speech channel signal, and the processing unit is configured to subtract a signal common to the main speech channel signal and the sub speech channel signal from the main speech channel signal or the sub speech channel signal to emphasize the speech signal when the discrimination unit determines that the signal mode indicates a sound multiplex signal.

11. The speech recognition apparatus according to claim 5, wherein the discrimination unit is configured to discriminate whether the signal mode indicates a bilingual signal including a first speech channel signal of a first language and a second speech channel signal of a second language, and the processing unit is configured to subtract a signal common to the first speech channel signal and the second speech channel signal from the first speech channel signal or the second speech channel signal to emphasize the speech signal when the discrimination unit determines that the signal mode indicates a bilingual signal.

12. A speech recognition program stored in a recording medium, the program comprising:
means for instructing a computer to discriminate a signal mode of a multi-channel audio signal including a speech signal and a non-speech signal for each channel;
means for instructing the computer to process the audio signal according to a discrimination result of the signal mode to separate substantially the speech signal from the audio signal; and
means for instructing the computer to subject the speech signal to speech recognition.
